(19) United States
(12) Patent Application Publication
(10) Pub. No.: US 2008/0286070 A1
(43) Pub. Date: Nov. 20, 2008

(54) Probe device for the docking station

(75) Inventor: Chwei-Lung Chiou, Taipei (TW)

Correspondence Address: BACON & THOMAS, PLLC, 625 SLATERS LANE, FOURTH FLOOR, ALEXANDRIA, VA, 22314-1176, US

(73) Assignee: Santa Electronics Inc., Taipei (TW)

(21) Appl. No.: 12/071,824

(22) Filed: Feb. 27, 2008

(30) Foreign Application Priority Data
May 17, 2007 (TW) 96208006
Nov. 23, 2007 (TW) 96219894

(51) Int. Cl. F16B 37/14

(52) U.S. Cl. 411/372.5

(57) ABSTRACT

The invented probe device comprises a base and a probe. The probe comprises a cap and an elastic member. The elastic member provides a force to push the cap ourwardly. The cap has a cylinder and a substantially slope peripheral at the top of the cylinder. The probe may further comprise a support, slidably connected with the cap. In the lower part of the support a notch is formed and screw threads are form at the side faces except at the surface of the notch. A fixing hole is provided in the base. The fixing hole has a recession so that the shape of the hole matches with the cross-sectional contour of the lower part of the support. A nut secures the lower part of the support tightly to the base.

### FIELD OF THE INVENTION

The present invention relates to a probe device for the docking station, especially to a probe device to be provided between a docking station and a portable device, to eliminate the electromagnetic interference and to assist the ejection mechanism of the docking station to eject the portable device.

### BACKGROUND OF THE INVENTION

The so-called “docking station” is a device used in a fixed electronic device to allow a portable device to connect the fixed device, so that the portable device and the fixed electronic device may exchange their data. The most popular application of the docking station is in the desktop computer. The docking station of the desktop computer allows the portable devices, such as the portable phone, the personal digital aid etc., to connect the desktop computer. Other applications of docking station include: The fixed input/output device assembly, to be connected with the notebook PC or the personal digital aid (PDA), in order to expand the functionality of the Notebook PC and the PDA. In addition, the Docking station may also provide the connection between the storage device and the electronic device or the communication network.

In the conventional technology, a fixed-type electronic device is in connection with the docking station, which provides at least one connector so that the portable device may connect the fixed-type electronic device through the docking station through an applicable communication interface. The communication interface is usually one of the standard series or parallel communication interfaces, while it is possible to use a specifically defined interface. In addition, there are EMI (electromagnetic interference) reduction regulations in most countries. According to the EMI related regulations, the docking station needs to provide probes that may contact the conductive wires provided in the circuit board of the portable devices, so that the electromagnetics generated by the portable device may be guided to the GROUND of the docking station.

Nevertheless, the docking station provides an ejection mechanism, which comprises a lever or the like and a push button and allows the user to eject and remove the portable device by pushing the push button when the portable device is in connection with the docking station.

FIG. 1 shows the structure of a conventional provide device for the docking station. The probe device is shown in the “Improvements in the EMI reduction prove” in the utility model application No. 91218859, Taiwan. As shown in this figure, the probe device 20 has a cap 21 and a support 24. The cap 21 is slidably supported by the support 24 and regulated by a ring 23. In other words, the upper edge of the ring 23 is screwed or riveted to the inner edge of the cap 21. In the lower edge of the ring 23 a lip extended to the inner of the ring 23. A lip is provided in the upper end of the support 24, which as a diameter slightly greater than that of the inner diameter of the lip of the ring. The ring 23 is pivoted in the support 24, then screwed or riveted to the cap 21. As a result, the cap 21, along with the ring 23, is provided in the support, slidably along the long axis of the support 24.

In the support 24 a spring 22 is provided and is fixed to the cap 21. The spring 22 enables the cap 21 to elastically slide back and forth along the longitudinal axis of the support 24. A base 1 may be provided. A fixing hole 11 is provided in the base 1 to fix the support 24 in the fixing hole 11.

To connect a portable device (not shown) with the docking station, the user simply needs to align the connector of the docking station with the communication interface device of the portable device and the connecting concaves of the portable device with the probes of the cocking station, connect the connector of the docking station and the communication interface device of the portable device and insert the probes into the connecting concaves, whereby the metal surface of the connecting concaves and the probes are in electric connections. The metal surface of the connecting concaves is in electric connection with the main board of the portable device. As a result, the electromagnetics generated by the elements of the portable device will be carried to the GROUND of the docking station.

In the above-mentioned procedure, the spring 22 provides certain elastic forces to the cap 21, so that the cap 21 may move in response to the pressures from the casing of the portable device during the interactions of the portable device and the docking station. Damages to the cap during the interactions may thus be avoided. The cap disclosed in the above-said utility model has a cone shape and a round top. The particular design in the shape of the cap 21 can further prevent the cap 21 from being damages during the interactions of the portable device and the docking station. When the cap 21 enters into the connecting concave of the portable device, the elastic forces of the spring 22 will press the cap against the connecting concave, whereby the cap 21 and the inner metal surface of the connecting concave may contact with each other tightly.

In the above utility model, the cap 21 is formed a cone shape with a round top, in order to avoid the probe from being damages during the connection and the disconnection of the portable device and the docking station. However, in the docking station where the probe is use, elements with certain thickness would be provided around the cap of the probe. When the probe is assembled to the docking station these elements would hinder the cone-shape cap from being tightly connected to the metal surface of the connecting concave, especially in the area of the lower parts of the cone shape. As a result, perfect connections between the probe and the connecting concave can not be realized.

In addition, in the above design, the support 24 is affixed to the base 1 by screwing, riveting or soldering the support 24 to the fixing hole 11. When the support 24 is screwed to the base 1, screw threads are provided at the lower part of the support 24 and at the internal surface of the fixing hole 11. If the support is riveted to the base 1, the diameter of the fixing hole 11 shall be slightly smaller than that of the lower part of the support 24. If the support 24 is soldered to the base 1, the solder flux is applied to the lower part of the support 24 and the high temperature is used to solder the lower part of the support 24 in the fixing hole 11.

None of the above-mentioned methods is easy in the assembling of the probe, as its elements are in small sizes. When screwing, riveting or soldering the support to the base, a fixture to sustain the support or the base is necessary. After the assembling, the secured affixation of the support and the base is not ensured. Therefore, in the probe assembly a spring with stronger force can not be used, to provide the force to eject the portable device away from the docking station when the portable device is to be removed from the docking station. In addition, in most applications, the portable device ejection mechanism is provided at side areas of the docking station. This is because the connector of the docking station needs to be provided in the center of the docking station. Since only the ejection mechanism provides the force to eject the portable device, the ejecting force would make the casing of the portable device deformed, when the portable device is removed from the docking station.

It is thus necessary to provide a novel probe device for the docking station, to ensure the securely connections between the probe and the connecting concave of the portable device.

It is also necessary to provide a new probe device for the docking station, whereby the assembly of the probe device may be simplified.

It is also necessary to provide a new probe device for the docking station that may provide the ejection forces when the portable device is removed from the docking station.

### OBJECTIVES OF THE INVENTION

The objective of this invention is to provide a novel probe device for the docking station, with which the securely connections between the probe and the connecting concave of the portable device may be ensured.

Another objective of this invention is to provide a new probe device for the docking station with low manufacture costs and simplified assembly process.

Another objective of this invention is to provide a new probe device for the docking station that may provide the ejection forces when the portable device is removed from the docking station.

### SUMMARY OF THE INVENTION

According to the present invention, a probe device for the docking station is disclosed. The probe device comprises a base and a probe. The probe comprises a cap and an elastic member. The elastic member provides a force to push the cap outwardly after it is compressed. The cap has a cylinder and a substantially slope peripheral at the top of the cylinder. The probe may further comprise a support, slidably connected with the cap. In the lower part of the support a notch is formed and screw threads are form at the side faces except at the surface of the notch. A fixing hole is provided in the base. The fixing hole has a recession so that the shape of the hole matches with the cross-sectional contour of the lower part of the support. When connecting the support and the base, the lower part of the support is provided in the fixing hole and a nut secures the lower part of the support until the support is tightly affixed to the base. The assembly so prepared provides greater elastic forces than the conventional probe devices. When the invented probe device is installed in the docking station, it provides the force to eject the portable device, when the portable device is removed from the docking station. In the preferred embodiments of the present invention, at least two probes are used in the central area of the docking station, so to provide additional ejecting forces in addition to that of the portable device ejection mechanism.

These and other objectives and advantages of the present invention may be clearly understood from the detailed description by referring to the following drawings.

### BRIEF DESCRIPTION OF THE DRAWINGS

FIG. 1 shows the structure of a conventional probe for the docking station.

FIG. 2 shows the structure of one embodiment of the probe device for the docking station of this invention.

FIG. 3 shows the elements of the probe device of this invention.

FIGS. 4A-4D show several embodiments in the shape of the cap of the probe device of this invention.

FIG. 5A is the bottom view of the invented probe, FIG. 5B shows the base and its fixing hole and FIG. 5C shows the top view of the fixing hole.

### DETAILED DESCRIPTION OF THE INVENTION

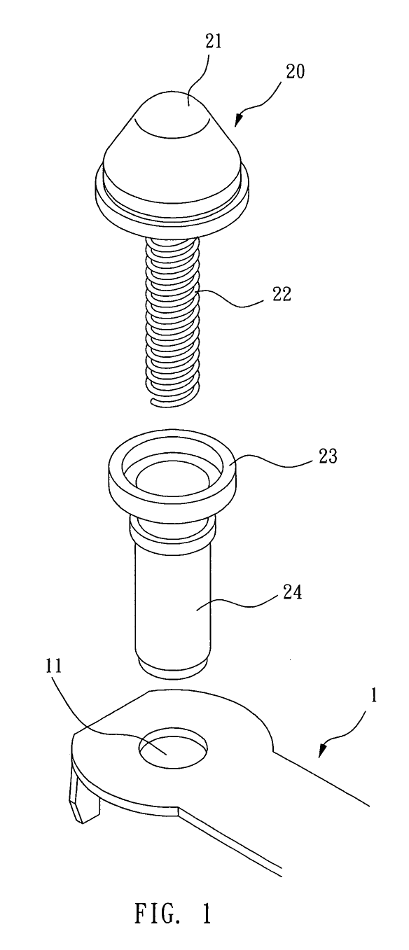

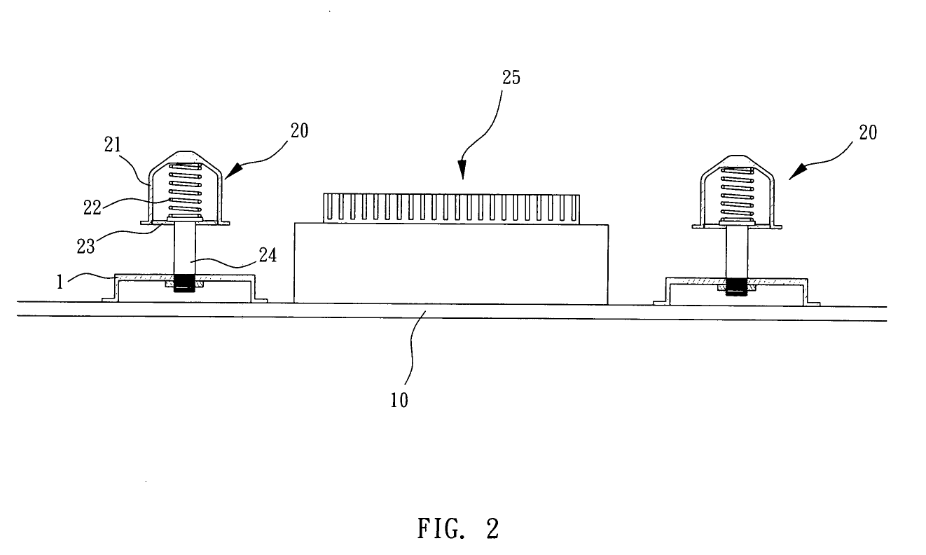

The embodiments of the probe device for the docking station will be described in the followings. FIG. 2 shows the structure of one embodiment of the probe device for the docking station of this invention. In FIG. 2 the elements that correspond to that in the FIG. 1 are labeled with the same numbers.

The probe device for the docking station of this invention comprises a base 1 and a probe 20. As shown in FIG. 2, two probes 20, 20 are provided in a main board 10. A connector slot 25 is provided in the main board 10, to allow the connection of a portable device.

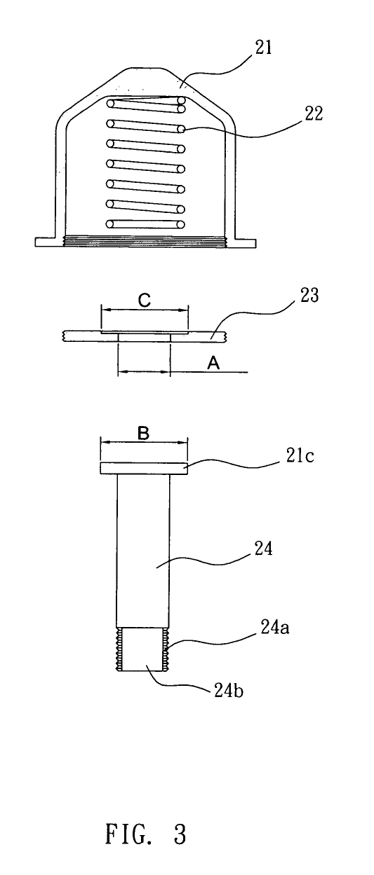

The probe 20 comprises a cap 21, an elastic member 22 and a support 24. In this figure, the cap 21 is a cylinder, with a substantially slope peripheral at the top of the cylinder. The elastic member 22 is a helix compression spring. The spring 22 provides the forces to eject the cap 21 against the connecting concave provided in the portable device. FIG. 3 shows the structure of the elements of the probe.

The cap 21 may be prepared using low cost and conductive materials, such as copper, stainless steel etc. Other conductive materials may also be used to produce the cap. If the cap is metal, it may be formed using a mold, a lathe or a milling machine or other tools. It is also possible to prepare use non-conductive materials such as plastics, resins, ceramics etc., to prepare the cap, followed by forming a conductive layer on the surface of the cap. Applicable methods to form the conductive layer include the electric plating, the vapor deposition and other commercially available methods. The elastic member 22 is not limited to the helix compression spring. Any element that is able to provide the forces to eject the cap upwardly may be used in this invention. The material of the elastic member 22 is not limited to the conductive. Non-conductive materials are applicable.

The cap 21 and the elastic member 22 may be affixed with each other in any applicable method, including soldering, riveting, adhesion and other known methods. Although it is not indented to limit the scope of this invention by any theory, it is discovered by the inventor that even if the support and the slidable connection member are not used, as they are used in the conventional art, the cap 21 may provide its functions under the regulations of the elastic member 24 and the elements surrounding the cap. This is because the space defined by the main board, the casing and other elements of the docking station will well regulate the movement of the cap.

The support 24 and the cap 21 are slidably connected, such that the cap 21 may slide back and forth along the longitudinal axis of the support 21. An applicable method to realize this is to use a slidable connection member 23. In the embodiment in FIGS. 2 and 3, the cap 21 has a cylindrical shape, with a substantially slope peripheral at its top portion. The support 24 is a round tube. In this embodiment, the slope peripheral 21a of the cap 21 shall not have a small slope angle. Such a cap has an upward cylinder portion 21b, a slope peripheral portion 21a and a top portion 21c, as shown in FIG. 2.

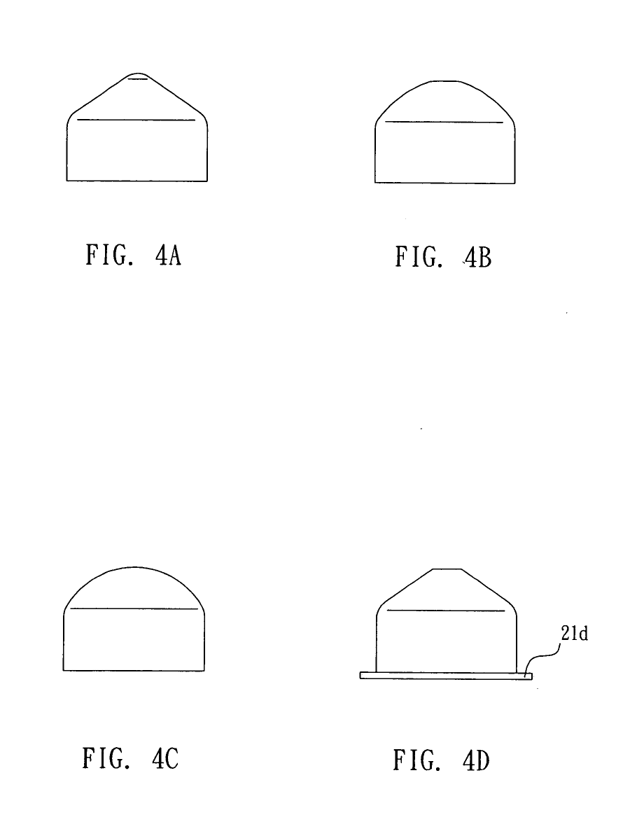

In other embodiments of the cap 21, the slope peripheral portion 21a and the top portion 21c form a cone-shape top, as shown in FIG. 4A. In another embodiment the slope peripheral portion 21a forms a spherical or arc shape, as shown in FIG. 4B. In a further embodiment the slope peripheral portion 21a and the top portion 21c form a round top, as shown in FIG. 4C. If necessary, an additional tongue piece 21d may be provided between the slope peripheral portion 21a and the top portion 21c, as shown in FIG. 4C. FIGS. 4A-4D provided several examples of the shape of the cap 21, while other derivatives may be used in this invention according to the needs of the probe device. Detailed descriptions thereof are thus omitted.

The inner diameter of the cap 21 shall be slightly larger than that of the outer diameter of the support 24, so that the support 24 may move along the central axis of the cap 21 in side the cap 21, when the cap 21 is mounted on the support 24. In the figure the slidable connection member 23 is a ring. Screw threads are provided at the upper side, i.e., the side facing the cap 21, of the ring 23, to be matched with the screw threads formed at the inner side of the lower edge of the cap 21, in order to secure the cap to the ring 23. At the lower part of the ring 23 an extruder (not shown) extended to the inner of the ring is provided, to define an inner diameter A. The upper end, i.e., the end facing the cap 21, of the support 24 forms an extruder 21e extended to the outer, to define an outer diameter B. The outer diameter B is slightly smaller than the inner diameter C of the ring 23 but is greater than the inner diameter A defined by the lip of the cap 23.

When assembled the lower part of the support 24 is pivoted in the ring 23, the spring 22 is then placed into the support 24 and lastly the ring 23 is screwed to the cap 21. At the lower part of the support 24 a base plate or a stop (not shown) may be provided to support the spring 22. In the assembly so finished the cap 21 covers the support 24 and slides up and down along the support 24 in response to the pressure from above the cap 21.

The slidable connection member 23 and the support 24 may be prepared with the metal or other conductive materials. The connection of the cap 21 and the slidable connection member is not limited to bolt and nut. Another applicable method is the rivet. It is also possible to solder the cap 21 to the slidable connection member 23. The method to form the lips of the slidable connection member 23 and of the support 24 include soldering, riveting, adhesion and other applicable methods.

The probe may be affixed to the base 1 or directly to the main board 10, without the help of the base 1. In such a case, a fixing hole (not shown) is provided in the main board 10 to fix the support 24. The base 1 and the main board 10 may be connected in any method. The base is in electric connection with the GROUND of the main board of the docking station. When the portable device is in connection with the docking station the probes of the docking station are positioned inside the EMI connecting concaves of the portable device, whereby the probes and the connecting concaves are in electric connection. The electromagnetics generated by the elements of the portable device may thus carried to the GROUND of the docking station through the probe 20 and the base 1.

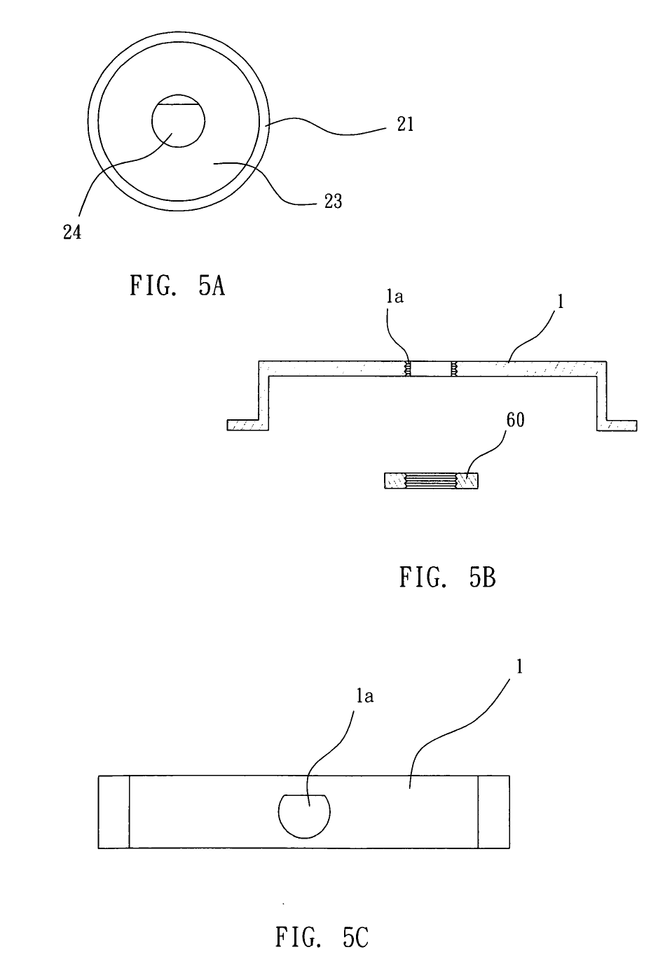

FIGS. 5A-C show the steps of the assembling of the base 1 and the support 24. FIG. 5A is the bottom view of the probe. The figure shows the structure of the bottom side of the support 24. FIG. 5B shows the structure of the base 1 and its fixing hole 1a. FIG. 5C shows the top view of the fixing hole 1a of the base 1. As shown in FIG. 3 and FIG. 5A, at the lower part of the support 24 a notch 24b is formed and screw threads 24a are form at the side faces except at the surface of the notch 24b. A fixing hole 25a is provided in the base 1. As shown in FIG. 5C, the fixing hole 25a has a recession so that the shape of the hole 25a matches with the cross-sectional contour of the lower part of the support 24. When the lower part of the support 24 enters into the fixing hole 1a of the base 1, a nut 26 with corresponding screw threads secures the support 24 to the base 1 until the support 24 is firmly affixed to the base 1. As shown in FIG. 5B, the fixing hole 25a and the cross-sectional contour of the lower part of the support 24 have the identical shape. The assemble of these elements is thus made easier; no additional fixture is needed. In addition, since the support 24 is secured to the base 1 using the nut 26 at the fixing hole 1a, strong connections between the support 24 and the base 1 are realized. As a result, an elastic member with stronger forces may be used in the probe 20. The probe 20 so prepared does not only provide the function of carrying the electromagnetics but also provides the ejection forces to assist the portable device ejection mechanism to eject the portable device, when the portable device is removed from the docking station. As a plurality of probes may be provided at adjacent to the connector of the docking station, they will make the removal of the portable device from the docking station easier.

In the examples where no base 1 is used, the fixing hole 1b is provided in the main board 10. The fixing hole has a recession such that the shape of the fixing hole matches with the cross-sectional contour of the lower part of the support 24. A nut 26 secures the support 24 to the main board 10 at the fixing hole 1a.

The probe as prepared as above may be used in the docking station. When the user moves the portable device horizontally when connecting the portable device to the docking station, the probes in the docking station won't be damages, because the cap 21 will be regulated by the slope peripheral portion and moves in response to the forces from the portable device. When the portable device is in connection with the docking station, the forces applied to the cap 21 disappear. The cap 21 will be pushed against the EMI connecting concave of the portable device by the forces of the elastic member 22. Thereby, effective electric contacts between the probe and the EMI connecting concave may be realized. When the portable device is removed from the docking station, the cap again moves smoothly in response to the forces applied to it. Damages or even breakage of the probe is thus prevented.

The cylindrical portion 21b of the cap 21 compensates the thickness of the elements surrounding the probe and the thickness of the elements surrounding the probe regulates the movements of the cap 21.

In the embodiment of FIG. 2, an electric connector 25 is provided in the main board 10. In this embodiment at least two probes 20, 20 are provided and positioned at the two sides of the electric connector 25, to provide additional ejection forces. Because in the present invention elastic member with stronger forces may be used, the probes do not only function as the EMI prevention element but also the ejection element for the portable device. The probe of this invention is small size, low cost and easy to assemble. It is thus possible to provide a plurality of probes in a docking station, to share the burdens of the portable device ejection mechanism during the disconnection procedure of the portable device.

In another embodiment of this invention, a series of 4 probes is provided at each side of the electric connector 25. To remove the portable device from the docking station is thus made easier.

Although the probe device of the present invention is mainly used in the docking station, it may be used in other devices, such as in the main board of the personal computer or other computer devices. It is also possible to provide the probe in the portable device and the EMI connecting concave in the docking station to obtain similar effects.

As the present invention has been shown and described with reference to preferred embodiments thereof, those skilled in the art will recognize that the above and other changes may be made therein without departing form the spirit and scope of the invention.

What is claimed is:

1. A probe device for the docking station, comprising a base and a probe; wherein said probe comprises:
a cap, comprising a cylinder portion, a top portion and a substantially slope peripheral portion between said cylinder portion and said top portion;
an elastic member to provide ejecting forces to said cap after said elastic member is compressed; and
a support, affixed in said base and slidably connected with said cap;
wherein a notch and screw threads are provided at a lower part of said support;
a fixing hole is provided in said base, said fixing hole having a recession having a shape in correspondence with said notch; and
a nut with screw threads corresponding to said screw threads of said support is provided to secure said support to said base at said fixing hole.

2. The probe device according to claim 1, wherein said slope peripheral and said top portion of said cap form a cone shape.

3. The probe device according to claim 1, wherein said slope peripheral of said cap comprises an arc shape.

4. The probe device according to claim 1, wherein said slope peripheral and said top portion of said cap form a round top.

5. The probe device according to claim 1, further comprising a tongue piece positioned between said slope peripheral portion and said cylinder portion.

6. The probe device according to claim 1, wherein said elastic member comprises a spring.

7. The probe device according to claim 1, wherein said elastic member comprises a compressing spring.

8. The probe device according to claim 1, further comprising a slidable connection member to slidably connect said support and said cap.

9. The probe device according to claim 8, wherein said slidable connection member is a ring.

10. A probe device assembly, comprising a substrate and at least two probe devices; each probe device comprising a base and a probe; wherein said probe comprises:
a cap, comprising a cylinder portion, a top portion and a substantially slope peripheral portion between said cylinder portion and said top portion;
an elastic member to provide ejecting forces to said cap after said elastic member is compressed; and
a support, affixed in said base and slidably connected with said cap;
wherein a notch and screw threads are provided at a lower part of said support;
a fixing hole is provided in said base, said fixing hole having a recession having a shape in correspondence with said notch.

11. The probe device assembly according to claim 10, wherein said slope peripheral and said top portion of said cap form a cone shape.

12. The probe device assembly according to claim 10, wherein said slope peripheral of said cap comprises an arc shape.

13. The probe device assembly according to claim 10, wherein said slope peripheral and said top portion of said cap form a round top.

14. The probe device assembly according to claim 10, further comprising a tongue piece positioned between said slope peripheral portion and said cylinder portion.

15. The probe device assembly according to claim 10, further comprising an electric connector affixed to said substrate

16. The probe device assembly according to claim 10, wherein said elastic member comprises a spring.

17. The probe device assembly according to claim 16, wherein said elastic member comprises a compressing spring.

18. The probe device assembly according to claim 10, further comprising a slidable connection member to slidably connect said support and said cap.

19. The probe device assembly according to claim 18, wherein said slidable connection member is a ring.
